(19) United States
(12) Patent Application Publication
(10) Pub. No.: US 2016/0265905 A1
(43) Pub. Date: Sep. 15, 2016

(54) DISTRIBUTED STRAIN MONITORING FOR DOWNHOLE TOOLS

(71) Applicants: Roger Glen Duncan, Christiansburg, VA (US); Colin M. Clarke, Calgary (CA); Asad Babar, Calgary (CA)

(72) Inventors: Roger Glen Duncan, Christiansburg, VA (US); Colin M. Clarke, Calgary (CA); Asad Babar, Calgary (CA)

(73) Assignee: Baker Hughes Incorporated, Houston, TX (US)

(21) Appl. No.: 15/019,052

(22) Filed: Feb. 9, 2016

Related U.S. Application Data
(60) Provisional application No. 62/130,027, filed on Mar. 9, 2015.

(51) Int. Cl. G01B 11/16; E21B 47/00

(52) U.S. Cl. CPC G01B 11/16; E21B 47/0007

(57) ABSTRACT

An apparatus for monitoring strain on a downhole component includes a fiber optic sensor having a length thereof in operable relationship with a downhole component and configured to deform in response to deformation of the downhole component. The fiber optic sensor defines a continuous, distributed sensor. An interrogation assembly is configured to transmit an electromagnetic interrogation signal into the fiber optic sensor and is configured to receive reflected signals therefrom. A processing unit is configured to receive information from the interrogation assembly and is configured to determine a strain on the downhole component during running of the downhole component to depth in a borehole.

### CROSS REFERENCE TO RELATED APPLICATIONS

This application claims the benefit of an earlier filing date from U.S. Provisional Application Ser. No. 62/130,027 filed Mar. 9, 2015, the entire disclosure of which is incorporated herein by reference.

### BACKGROUND

Fiber-optic sensors have been utilized in a number of applications, and have been shown to have particular utility in sensing parameters in harsh environments.

Different types of motors and other downhole tools are utilized in downhole environments in a variety of systems, such as in drilling, pumping, and production operations. For example, electrical submersible pump systems (ESPs) are utilized in hydrocarbon production to assist in the removal of hydrocarbon-containing fluid from a formation and/or reservoir. ESPs and other systems are disposed downhole in a borehole, and are consequently exposed to harsh conditions and operating parameters that can have a significant effect on system performance and useful life of the systems.

Currently, when a well, such as a steam assisted gravity drainage (SAGD) well for example, is drilled with conventional directional tools, doglegs can be developed in the well and may go undetected. Sometimes there is a severe dogleg in the tangent section and when the pump is landed or placed in the tangent section, there may be stresses induced on the rotating components of the ESP. The stresses may also be imposed on potentially weak, flanged connections between pipe sections and/or between pipe sections and connected downhole tools. These stresses can greatly affect ESP and/or other downhole tools' run life and, as such, may cause expensive workover and replacement costs. Additional costs may result from lost production while the pump is not running.

Currently systems for detecting stresses downhole include point sensors that are located at joints or connections between pipe segments, which may be located about every thirty feet on production tubing. Thus, when a pump is to be landed, an operator can detect a section of well bore that is estimated to be relatively flat based on two points that are about thirty feet apart. If the two points are at the same depth horizontally, an operator may assume a level landing section for the ESP. However, because there is an uncertainty within well bores, including doglegs that are shorter than thirty feet long, it is possible that an ESP may be landed at an assumed flat location, but in fact may be within a dogleg and thus subject to strains that may negatively impact the life and operation of the ESP, without the knowledge of the operator.

### SUMMARY

An apparatus for monitoring a strain on a downhole component is provided. The apparatus includes a fiber optic sensor having a length thereof in an operable relationship with a downhole component and configured to deform in response to deformation of the downhole component. The fiber optic sensor defining a continuous, distributed sensor. An interrogation assembly is configured to transmit an electromagnetic interrogation signal into the fiber optic sensor and configured to receive reflected signals therefrom. A processing unit is configured to receive information from the interrogation assembly and is configured to determine a strain on the downhole component during running of the downhole component to depth in a borehole.

A method of monitoring a strain on a downhole component is provided. The method includes disposing a length of an fiber optic sensor in a fixed relationship relative to a downhole component, the fiber optic sensor configured to deform in response to deformation of the downhole component, the fiber optic sensor defining a continuous distributed sensor; running the downhole component into a borehole to a potential landing site; transmitting an electromagnetic interrogation signal into the fiber optic sensor during running of the downhole component; receiving reflected signals from the fiber optic sensor during running of the downhole component; and determining a strain on the downhole component from the received reflected signal during the running of the downhole component.

### BRIEF DESCRIPTION OF THE DRAWINGS

The following descriptions should not be considered limiting in any way. With reference to the accompanying drawings, like elements are numbered alike:

FIG. 1 is a cross-sectional view of an embodiment of a downhole drilling, monitoring, evaluation, exploration and/or production system;

FIG. 2 is a cross-sectional view of an ESP located downhole in accordance with an exemplary embodiment of the present disclosure;

FIG. 3 is a schematic view of an ESP in accordance with an exemplary embodiment of the present disclosure; and

FIG. 4 is a flow chart illustrating a method of monitoring strain of a downhole tool in accordance with an exemplary embodiment of the present disclosure.

The detailed description explains embodiments of the present disclosure, together with advantages and features, by way of example with reference to the drawings.

### DETAILED DESCRIPTION OF EXEMPLARY EMBODIMENTS

Apparatuses, systems, and methods for monitoring strain on downhole components and/or tools are provided. Such apparatuses and systems are used, in some embodiments, to estimate the strain applied to a downhole tool during running to depth over a distributed area of the components and/or tools. In some embodiments, such apparatus and systems are used in dummy ESP systems that are deployed prior to production ESP deployment in an effort to determine an ideal position for landing the production ESP. In some embodiments, a monitoring system includes a fiber optic sensor having a length thereof in an operable relationship with a downhole component and configured to deform in response to deformation of the downhole component. The fiber optic sensor defining a continuous, distributed sensor. An interrogation assembly is configured to transmit an electromagnetic interrogation signal into the fiber optic sensor and configured to receive reflected signals therefrom. A processing unit is configured to receive information from the interrogation assembly and is configured to determine a strain on the downhole component during running of the downhole component to depth in a borehole. Further, in some embodiments A method of monitoring a strain on a downhole component is provided. The method includes disposing a length of an fiber optic sensor in a fixed relationship relative to a downhole component, the fiber optic sensor configured to deform in response to deformation of the downhole component, the fiber optic sensor defining a continuous distributed sensor; running the downhole component into a borehole to a potential landing site; transmitting an electromagnetic interrogation signal into the fiber optic sensor during running of the downhole component; receiving reflected signals from the fiber optic sensor during running of the downhole component; and determining a strain on the downhole component from the received reflected signal during the running of the downhole component.

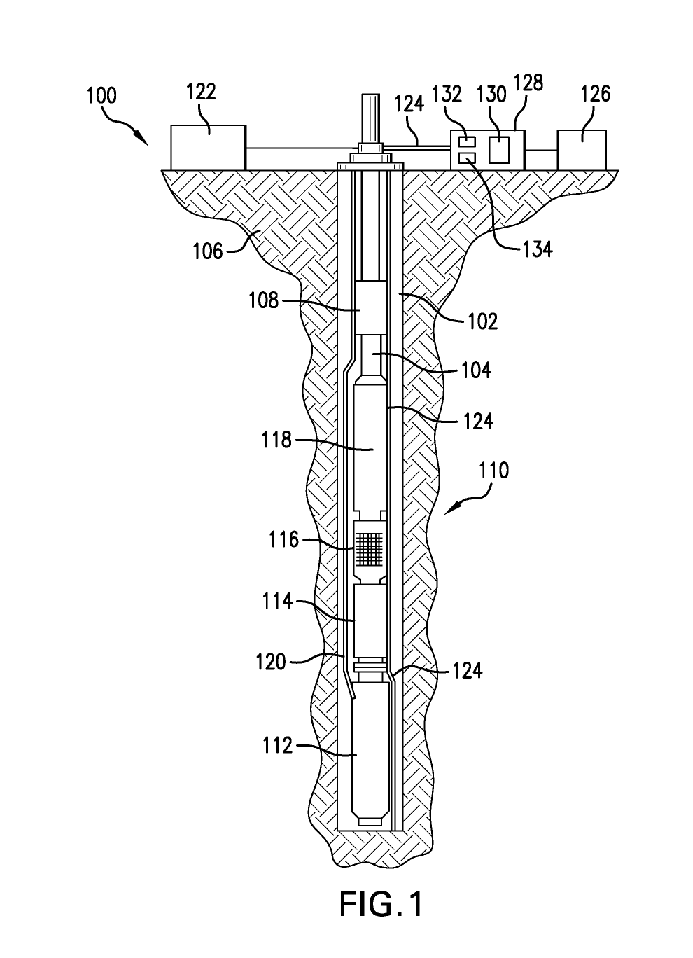

Referring to FIG. 1, an exemplary embodiment of a downhole drilling, monitoring, evaluation, exploration, and/or production system 100 associated with a borehole 102 is shown. A borehole string 104 is run in the borehole 102, which penetrates at least one earth formation 106 for facilitating operations such as drilling, extracting matter from the formation, sequestering fluids such as carbon dioxide, and/or making measurements of properties of the formation 106 and/or the borehole 102 downhole. The borehole string 104 includes any of various components to facilitate subterranean operations. The borehole string 104 is made from, for example, a pipe, multiple pipe sections, or flexible tubing. The borehole string 104 includes for example, a drilling system and/or a bottom-hole assembly (BHA).

The system 100 and/or the borehole string 104 include any number of downhole tools 108 for various processes including drilling, hydrocarbon production, and formation evaluation for measuring one or more physical properties, characteristics, quantities, etc. in and/or around a borehole 102. For example, the tools 108 may include a drilling assembly and/or a pumping assembly. Various measurement tools may be incorporated into the system 100 to affect measurement regimes such as wireline measurement applications and/or logging-while-drilling (LWD) applications.

In one embodiment, at least one of the tools 108 includes an electrical submersible pump (ESP) assembly 110 connected to the borehole string 104, which may be formed from production string or tubing, as part of, for example, a bottom-hole assembly (BHA). The ESP assembly 110 is utilized to pump production fluid through the borehole string 104 to the surface. The ESP assembly 110 includes components such as a motor 112, a seal section 114, an inlet or intake 116, and a pump 118. The motor 112 drives the pump 118, which is configured to take in fluid (typically an oil/water mixture) via the inlet 116, and discharge the fluid at increased pressure into the borehole string 104. The motor 112, in some embodiments, is supplied with electrical power via an electrical conductor such as a downhole power cable 120, which is operably connected to a power supply system 122 or other power source including a downhole power source.

The downhole tools 108 and other downhole components are not limited to those described herein. In one embodiment, the tool 108 includes any type of tool or component that experiences strain, deformation, or stress downhole. Examples of tools that experience strain and other impacts include motors or generators such as ESP motors, other pump motors and drilling motors, as well as devices and systems that include or otherwise utilize such motors. Further, the downhole components may be any downhole tool or element that is of sufficient length that doglegs and strain may impact that life and/or usefulness of the tool or element such as packers, etc. Thus, although described herein with respect to an ESP, this is presented for illustrative and explanatory purposes, and the embodiments of the present disclosure are not limited thereby.

The system 100 also includes one or more fiber optic components 124 configured to perform various functions in the system 100, such as communication and sensing various parameters. For example, fiber optic components 124 may be included as a fiber optic communication cable for transmitting data and commands between two or more downhole components and/or between one or more downhole components and one or more surface components such as a surface processing unit 126. Other examples of fiber optic components 124 include fiber optic sensors configured to measure downhole properties such as temperature, pressure, downhole fluid composition, stress, strain, and deformation of downhole components such as within the borehole string 104 and the tools 108. The optical fiber component 124, in some embodiments, is configured as an optical fiber communication line configured to send signals therein between components and/or between components and the surface. In alternative embodiments, the communication aspect of the optical fiber component 124 may be replaced and/or supplemented with wireless communication and/or other types of wired communication.

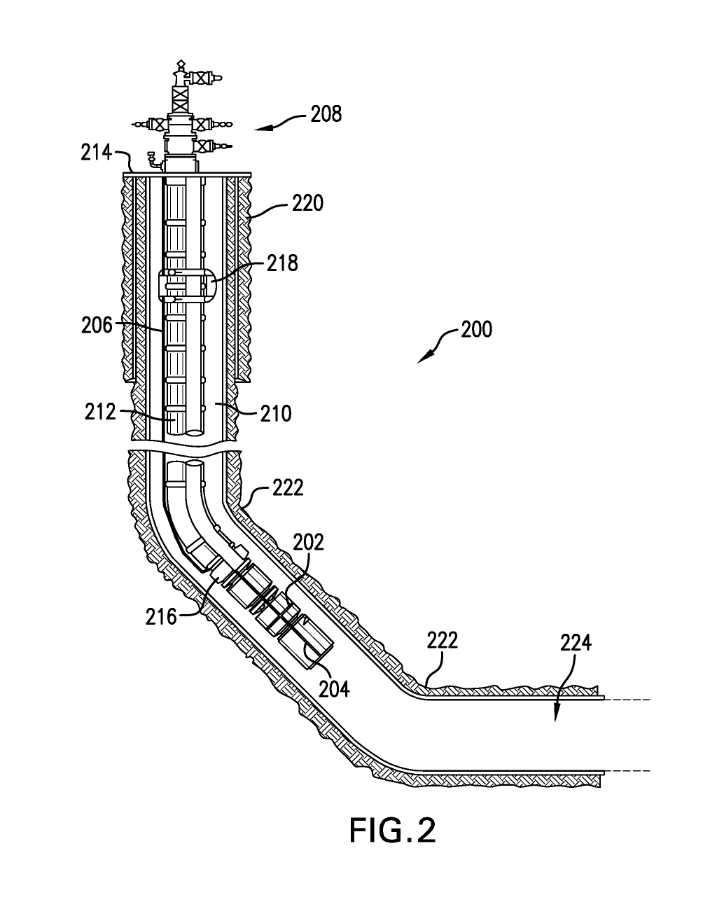

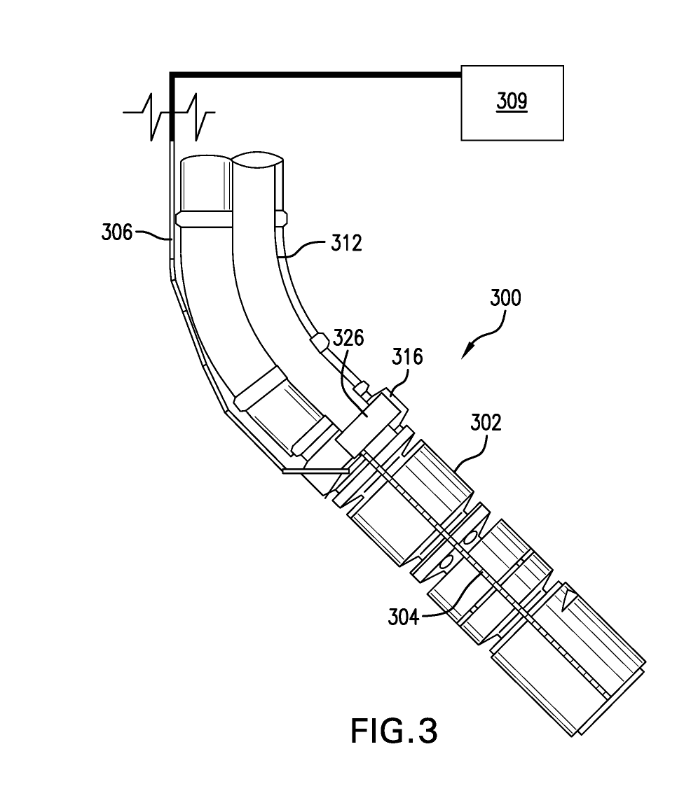

The system 100 also includes a monitoring system 128, such as an optical fiber monitoring system, configured to interrogate one or more of the optical fiber components 124 to estimate a parameter (e.g., strain) of or on the tool 108, ESP assembly 110, or other downhole component. In some embodiments, the monitoring system 128 may be configured to identify a change in a parameter such as strain. A change in strain may indicate that the downhole component is located in an inappropriate location, and enables an operator to adjust the position of the component such that the strain may be minimized, reduced, and/or eliminated. In some embodiments, at least a portion of the optical fiber component 124 or other optical fiber component is integrated with or affixed to a component of the tool 108, such as the ESP assembly 110 or a dummy ESP assembly (see, e.g., FIGS. 2 and 3). In some embodiments, the optical fiber component 124 may be attached to a housing or other part of the motor 112, the pump 118, or other component of the ESP assembly 110.

The monitoring system 128 may be configured as a distinct system or incorporated into other systems. The monitoring system 128 may incorporate existing optical fiber components such as communication fibers and temperature, vibration, and/or strain sensing fibers. Examples of monitoring systems include Extrinsic Fabry-Perot Interferometric (EFPI) systems, optical frequency domain reflectometry (OFDR), and optical time domain reflectometry (OTDR) systems.

The monitoring system 128 includes a reflectometer 130 configured to transmit an electromagnetic interrogation signal into the optical fiber component 124 and receive a reflected signal from one or more locations in the optical fiber component 124. The reflectometer unit 130 is operably connected to one or more optical fiber components 124 and includes an electromagnetic interrogation signal source 132 (e.g., a pulsed light source, LED, laser, etc.) and an electromagnetic signal detector 134. In some embodiments, the reflectometer 130 may include a processor that is in operable communication with the signal source 132 and/or the detector 134 and may be configured to control the source 132 and receive reflected signal data from the detector 134. In other embodiments, the system processor 126 may provide the features and processes just described. The reflectometer unit 130 includes, for example, an OFDR and/or OTDR type interrogator to sample the ESP assembly 110 and/or tool 108.

In some embodiments, the reflectometer unit 130 is configured to detect signals reflected due to the native or intrinsic scattering produced by an optical fiber. Examples of such intrinsic scattering include Rayleigh, Brillouin, and Raman scattering. The monitoring system 128 is configured to correlate received reflected signals with locations along a length of the borehole 102. For example, the monitoring system 128 is configured to record the times of reflected signals and associate the arrival time of each reflected signal with a location or region of the borehole 102. These reflected signals can be modeled as weakly reflecting fiber Bragg gratings, and can be used similarly to such gratings to estimate various parameters of the optical fiber 124 or other optical fibers and/or associated components. In this way, desired locations within the borehole 102 can be selected and do not depend on the location of pre-installed reflectors such as Bragg gratings and fiber end-faces. In some embodiments, the reflectometer 130 may be configured as an interferometer.

Turning now to FIG. 2, a strain monitoring system 200 in accordance with an exemplary embodiment is shown. The strain monitoring system 200 includes a monitoring device 202 with a sensor 204 disposed therewith. Sensor 204 may be operatively connected to a communication line 206 which is configured to communicate with surface devices 208. In an exemplary embodiment, the monitoring device 202 is a dummy ESP or housing having a sensor 204, such as a fiber optic sensor, disposed within and along a central axis of the dummy ESP. In such embodiments, the sensor 204 is optically connected to the communication line 206, which may be a fiber optic communications cable or line and configured to connect with one or more surface devices 208, such as an interrogator as described above. The interrogator may be based on optical frequency domain reflectometry (coherent or incoherent), Wavelength Division Multiplexing (WDM), and/or other optical interrogator methodologies.

The strain monitoring system 200 is run into and within a borehole 210, which may be drilled by one or more components of the surface devices 208, which may include a rig or other drilling apparatus. In the exemplary embodiment shown in FIG. 2, the monitoring device 202 is connected to production tubing 212 which extends from the surface 214 into the borehole 210 although other piping, tubing, or wireline may be used. A connector 216 connects the monitoring device 202 to the tubing 212. The connector 216 is configured for physical connection and/or attachment as well as enabling communication connection(s) between the monitoring device 202, the sensor 204, and the communication line 206. Further, as shown, a coupling 218 is configured to clamp, hold, and/or retain the communication line 206 to the tubing 212 and to prevent or minimize risk of damage to the communication line 206 while in-hole. In some embodiments, the coupling 218 may be configured as any type of coupling or clamp, known or that will become known, that is configured to clamp or retain the communication line 206 to the tubing 212.

In an exemplary embodiment, the monitoring device 202 is a housing that mimics the physical properties of an ESP and the sensor 204 is a distributed fiber optic strain monitoring cable. As used herein, the term “mimic” means to simulate or represent the physical characteristics of a downhole tool. For example, a housing that mimics a downhole tool, such as an ESP, may be configured to match the length, diameter, weight, stiffness, connections, etc. or any combination of physical attributes of an ESP. In such exemplary embodiment, the connector 216 is configured as a housing for fiber optic interrogation hardware and may include a battery power source. The communication line 206 is a standard fiber optic cable used for data transfer from the distributed fiber optic strain monitoring cable of sensor 204. A fiber optic splice connection from the standard fiber optic cable of communication line 206 is provided to enable optical coupling with the strain monitoring cable of sensor 204.

Distributed, as used herein, refers to the distribution of sensing of strain along the entire length, or a predetermined length, of a device, such as monitoring device 202. Thus, the strain imparted to all positions and locations on the device itself may be monitored. This enables a pin-point and accurate determination of the stress that is actually imposed on device when in-well, and thus guessing with respect to points that may be distant from a landing location may be eliminated. Further, as the sensing system may be employed actively during running in-well, the stresses imposed on the device (over the length of the device) may be monitored such that any potential stresses during running may be accounted for.

The borehole 210 is drilled into a formation 220. As noted above, when a well is drilled with directional tools, doglegs can be developed in the well and go undetected. For example, as shown in FIG. 2, high dogleg severity is shown at points or bends 222 in the borehole 210. Doglegs in the borehole may be formed by planned (directional drilling) trajectory changes, loads experienced or imparted during drilling, and/or formation changes within the borehole. A dogleg is a section in a borehole where the trajectory of the borehole, i.e., the curvature, changes. The rate of trajectory change is called dogleg severity (DLS) and is typically expressed in degrees per 100 feet.

For example, there may be a tangent section in a directional plan (i.e., during directional drilling) for the ESP to be run or landed, as shown in FIG. 2. There may be a dogleg in the tangent section, such as at points 222, and when an ESP is run through or is landed at these points 222, the stresses induced on the components of the ESP as well as any connections (such as connector 218) may be increased. These stresses can greatly affect ESP run life and, as such, may cause expensive workover and replacement costs along with production downtime.

In view of this, the strain monitoring system 200 is configured to accurately and efficiently monitor or predict the strain that an ESP may experience when in-hole, i.e., during running to depth and at a prospective or potential landing site. For example the strain monitoring system 200 may be configured to mimic the physical properties of an ESP, and thus when being run and at depth and within the borehole 210, the doglegs 222 may be avoided and/or accounted for. Further, when an ESP or other tool is run downhole, even if being landed at an optimal location, the tool may be subject to stress when passing through the doglegs 222, or through other parts of the borehole that may include projections that may impart stresses to the device when running downhole. Thus enabling the tool to be run and landed in an optimal location, such as on a flat or smooth section of the borehole 210, shown at section 224 of borehole 210, is advantageous.

During operation, the strain monitoring system 200 is configured to measure or determine the strain that would be imparted to a tool in real-time, continuously or periodically, and for every physical position or location of the tool when downhole (i.e., running and landing). This is enabled, in part, by the distributed fiber optic sensor 204 that measures and/or detects strain on the monitoring device 202 over the length of the monitoring device 202 in a real-time basis.

Referring now to FIG. 3, an enlarged view of a strain monitoring system 300 in accordance with an exemplary embodiment of the present disclosure is shown. Strain monitoring system 300 may be substantially similar to strain monitoring system 200 of FIG. 2, and thus similar features have the same reference numeral, but are preceded by a “3” rather than a “2.”

The strain monitoring system 300 includes a monitoring device 302 with a sensor 304 disposed therein. The sensor 304 extends along an axis of the monitoring device 302 for the entire length thereof. The monitoring device 302 is connected or attached to a connector 316 and the sensor 304 is operatively and/or optically connected with a communication line 306. The connector 316 is configured to attach the monitoring device 302 to tubing 312.

The sensor 304, in some embodiments, is configured as either at least two single core optical fibers or a multicore optical fiber having at least two fiber cores. In either case, the fiber cores are spaced apart such that mode coupling between the fiber cores is minimized. An array of fiber Bragg gratings are disposed within each fiber core and a frequency domain reflectometer is positioned in an operable relationship to the optical fibers. The sensor 304 is affixed to an interior of the monitoring device 302, which may merely be a housing that mimics the size and other dimensions of an ESP. As forces are applied to the monitoring device 302, the force is imparted or detected by the sensor 304. Thus, strain on the monitoring device 302 is imparted to the optical fiber of sensor 304 and may be measured. The strain measurements may then be correlated to local bend measurements of the monitoring device 302. Local bend measurements may then be integrated to determine position and/or shape of the object, and thus determine and/or predict if damage may occur to a downhole tool that is run in the borehole. In some exemplary embodiments, the sensor 304 may be a fiber optic shape sensing device such as disclosed in U.S. Pat. No. 7,781,724, which is hereby incorporated by reference in its entirety.

In an exemplary embodiment, the sensor 304 consists of an array of Fiber Bragg Grating (FBGs) interfaced with an Artificial Lift System (ALS), such as an Electrical Submersible Pump (ESP), in a manner that ensures transfer of strain to the fiber through the tool body (e.g., ESP body). The strain is then measured by interrogating the sensor array (sensor 304) with an appropriate interrogator 309 (which may be one of the surface devices 208 shown in FIG. 2). In such embodiments, the interrogator may be based on optical frequency domain reflectometry (coherent or incoherent), Wavelength Division Multiplexing (WDM), and/or other interrogation methodologies. In some embodiments, the sensor 304 may be interfaced with a stator of the ESP directly, or in some embodiments the sensor 304 may be interfaced with a stator indirectly (such as via a SureVIEW Wire-like implementation where the fiber is integrated into a cable or a tubular), or directly or indirectly through another part of the ESP with representative strains. By monitoring the strain distribution during running into a borehole and placement of the downhole tool at a potential landing site, it is possible to optimize the running and landing to improve the lifetime of the ESP or other downhole tool.

The sensor 304 is optically connected to the communication line 306 within the connector 316. Hardware 326 may be included within the connector 316 and configured to optically connect the sensor 304 with the communication line 306. At the surface end of communication line 306 may be the interrogator 309. In operation, the interrogator 309 is configured to send an electromagnetic interrogation signal through the communication line 306 and into to the sensor 304. The signal will then be reflected back into the communication line 306 and can be detected at the interrogator 309. The interrogator 309 can detect, through the received or reflected signal, strain that is experienced by the monitoring device 302, which reflects the current strain on the device 302. The interrogation enabled and performed by interrogator 309 is configured to be carried out during running of the monitoring device 302 into a borehole. Thus, real-time monitoring of strain on a downhole device may be monitored. In some embodiments, the interrogator 309 may be configured to continuously interrogate the sensor 304, and thus provide continuous strain data as the monitoring device 302 is run into a borehole. In other embodiments, the interrogator 309 may be configured to periodically interrogate the sensor 304. Periodic monitoring may provide information related to points of interest or predetermined points, at predetermined intervals, and/or upon a user prompting an interrogation.

In an alternative embodiment, with reference to FIG. 3, the communication line 306 may be eliminated or omitted. In such embodiments, the connector 316 and hardware 326 may be configured for wireless transmission of the strain data to the surface. For example, the hardware 326 may include an on-board interrogator therein. The on-board interrogator may be configured to transmit signals directly into the sensor 304 and receive reflected signals therefrom. The data may then be transmitted in real-time to the surface wirelessly, or to another device in the borehole, for example a storage device configured to record data received from the hardware 326. In alternative embodiments, the hardware 326 may be connected by a communication line (not shown) to other devices, such as storage devices or transmitting devices, which then store or relay the information received from the hardware 326.

In another alternative embodiment, the hardware 326 may be configured with a data logger, such as memory and/or a processor, as known in the art, that are configured to write and/or record data associated with the strain detected by the sensor 304. In such embodiments, the hardware 326 may also include an interrogator configured to transmit signals into and receive signals from the sensor 304. The data logger may then be extracted from the borehole for analysis to determine stresses imposed on the device 302 and determine and optimal landing location, and or be used to adjust and/or select an appropriate size or shape tool for in-well deployment.

In one embodiment, other parameters associated with the ESP may also be measured. Such parameters include, for example, temperature, vibration, pressure, etc. For example, the sensor 204/304 may also include additional sensing components that can be utilized to measure temperature as part of a distributed temperature sensing system.

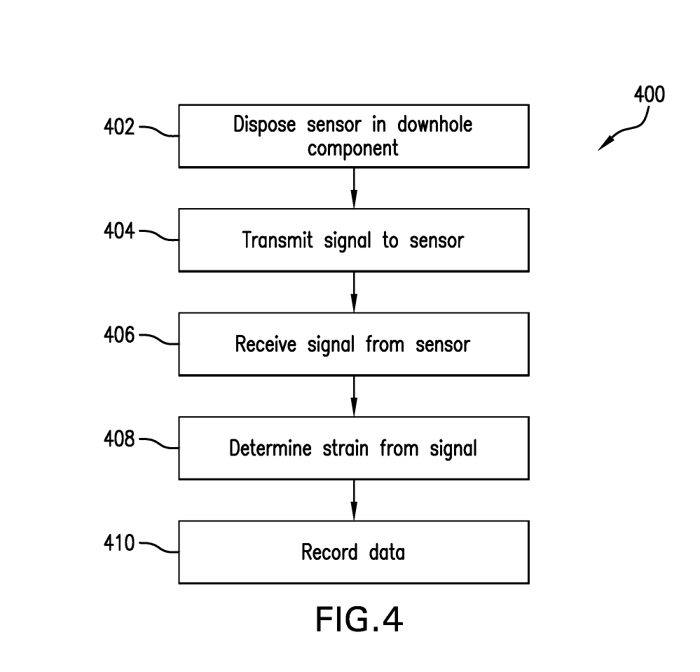

Turning now to FIG. 4, a process 400 for actively and continuously measuring strain experienced by a downhole tool during running in a borehole is shown. At step 402 a length of a fiber optic sensor is disposed in a fixed relationship relative to a downhole component that will be run into the borehole and may be used to determine an optimal landing site and/or downhole tool configuration. As described above the fiber optic sensor is configured to deform in response to deformation of the downhole component, and thus enable determination of strain imposed on the downhole component. In some embodiments, the fiber optic sensor defines a continuous distributed sensor, such as described above. At step 404, during running and at potential landing sites (continuously or periodically), an electromagnetic interrogation signal is transmitted into the fiber optic sensor from an interrogator. At step 406, the interrogator receives the reflected signals from the fiber optic sensor. From the received signal, at step 408, a strain on the downhole component is determined. At step 410, the determined strain may be recorded. In some alternative embodiments, the received signal may be recorded first, i.e., within a memory of the downhole tool, and the determination made after the recording is retrieved for processing. Retrieval of the signal may be by either transmission or physical retrieval of the monitoring device.

In some embodiments, the process 400 may occur completely in situ, that is, downhole at or in the downhole component, such as described above. In other embodiments, the received signal may be transmitted to another component, either downhole or on the surface, to then be processed to determine the strain. Further, in some embodiments, the transmitting and receiving steps occur during running and landing of the downhole component in a well, enabling real-time strain determinations.

Set forth below are some embodiments of the foregoing disclosure:

### Embodiment 1

An apparatus for monitoring strain on a downhole component, the apparatus comprising: a fiber optic sensor having a length thereof in an operable relationship with a downhole component and configured to deform in response to deformation of the downhole component, the fiber optic sensor defining a continuous, distributed sensor; an interrogation assembly configured to transmit an electromagnetic interrogation signal into the fiber optic sensor and configured to receive reflected signals therefrom; and a processing unit configured to receive information from the interrogation assembly and configured to determine a strain on the downhole component during running of the downhole component to depth in a borehole.

### Embodiment 2

The apparatus of embodiment 1, further comprising a communication line operatively connecting the fiber optic sensor and the interrogation assembly.

### Embodiment 3

The apparatus of embodiment 2, wherein the communication line is a fiber optic cable.

### Embodiment 4

The apparatus of embodiment 1, wherein the fiber optic sensor is an optical fiber sensor.

### Embodiment 5

The apparatus of embodiment 4, wherein the fiber optic sensor is a distributed fiber optic strain monitoring cable.

### Embodiment 6

The apparatus of embodiment 1, wherein the interrogation assembly is configured as part of the downhole component.

### Embodiment 7

The apparatus of embodiment 6, further comprising a data logger configured to record data from at least one of the interrogation assembly and the processing unit.

### Embodiment 8

The apparatus of embodiment 1, wherein the downhole component is a housing configured to mimic the physical properties of a downhole tool.

### Embodiment 9

The apparatus of embodiment 1, wherein the downhole component is operatively connected to a production string.

### Embodiment 10

The apparatus of embodiment 1, wherein the interrogation assembly is on a ground surface and in operative communication with the fiber optic sensor.

### Embodiment 11

The apparatus of embodiment 1, wherein the fiber optic sensor is disposed along a central axis of the downhole component.

### Embodiment 12

The apparatus of embodiment 1, wherein the processing unit is configured to continuously determine a strain on the downhole component during running of the downhole component to depth.

### Embodiment 13

The apparatus of embodiment 1, wherein the processing unit is configured to periodically determine a strain on the downhole component during running of the downhole component to depth.

### Embodiment 14

The apparatus of embodiment 1, wherein the processing unit is configured to determine a strain on the downhole component at a potential landing site.

### Embodiment 15

The apparatus of embodiment 1, wherein the downhole component is an electrical submersible pump.

### Embodiment 16

A method of monitoring strain on a downhole component, the method comprising: disposing a length of an fiber optic sensor in a fixed relationship relative to a downhole component, the fiber optic sensor configured to deform in response to deformation of the downhole component, the fiber optic sensor defining a continuous distributed sensor; running the downhole component into a borehole to a potential landing site; transmitting an electromagnetic interrogation signal into the fiber optic sensor during running of the downhole component; receiving reflected signals from the fiber optic sensor during running of the downhole component; and determining a strain on the downhole component from the received reflected signal during the running of the downhole component.

### Embodiment 17

The method of embodiment 16, further comprising recording the received reflected signals.

### Embodiment 18

The method of embodiment 16, wherein the determining step occurs in situ.

### Embodiment 19

The method of embodiment 16, wherein the fiber optic sensor is disposed along a central axis of the downhole tool.

### Embodiment 20

The method of embodiment 16, further comprising determining a strain on the downhole component at the potential landing site of the downhole component.

### Embodiment 21

The method of embodiment 16, further comprising transmitting at least one of the received reflected signal and the determined strain to a surface component.

### Embodiment 22

The method of embodiment 16, wherein the determining step occurs continuously during the running of the downhole component.

### Embodiment 23

The method of embodiment 16, wherein the determining step occurs periodically during the running of the downhole component.

The systems and methods described herein provide various advantages. The systems and methods provide a mechanism to measure strain in a distributed manner along a component in real-time and continuously during running into a borehole and during landing of a component at a landing site. In addition, the systems and methods allow for a more precise measurement of strain on the component at any or all locations within a borehole.

Further, advantageously, parameters could be set up that if the ESP experiences a certain amount of deformation while being deployed, adjustments may be made appropriately. For example, a modified or adjusted downhole component, such as a shorter system or a smaller ESP, could be run instead with a better chance of reaching depth without being damaged. Thus, the physical characteristics of a downhole tool may be configured to optimally run the downhole tool into a borehole, e.g., size, shape, diameter, length, types/strength of connections within a downhole component, etc., based on the strain monitoring during running downhole and landing.

In support of the teachings herein, various analyses and/or analytical components may be used, including digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present disclosure. These instructions may provide for equipment operation, control, data collection and analysis and other functions deemed relevant by a system designer, owner, user or other such personnel, in addition to the functions described in this disclosure.

While the present disclosure has been described in detail in connection with only a limited number of embodiments, it should be readily understood that the present disclosure is not limited to such disclosed embodiments. Rather, the embodiments of the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments and/or features.

For example, although described herein as an ESP, the downhole tool may be any downhole tool that may undergo strain during running and/or landing within a well. Thus, for example, the monitoring system may be configured to mimic pumps, sensors, motors, packers, production devices, etc., and the present disclosure is not limited to the above described and shown configurations.

Further, as described herein, the sensor and interrogator are configured as optical devices. However, those of skill in the art will appreciate that other types of sensors and/or configurations maybe used without departing from the scope of the present disclosure. For example, alternate interrogation methodologies may include Rayleigh scatter, Brillouin, etc., as known in the art. Further, other types of fiber optic sensors and/or methodologies may be used as known or will become known.

Further, in some embodiments, the sensor may be configured as an optical fiber that is integrated into motor windings that are configured to measure temperature and further configured to measure strain with the same or similar optical fibers.

Additionally, although described herein as part of a dummy ESP within a housing, those of skill in the art will appreciate that such sensors may be configured with operational downhole tools, other dummy or simulation type devices, etc., without departing from the scope of the present disclosure.

Accordingly, embodiments of the present disclosure are not to be seen as limited by the foregoing description, but are only limited by the scope of the appended claims.

What is claimed is:

1. An apparatus for monitoring strain on a downhole component, the apparatus comprising:
a fiber optic sensor having a length thereof in an operable relationship with a downhole component and configured to deform in response to deformation of the downhole component, the fiber optic sensor defining a continuous, distributed sensor;
an interrogation assembly configured to transmit an electromagnetic interrogation signal into the fiber optic sensor and configured to receive reflected signals therefrom; and
a processing unit configured to receive information from the interrogation assembly and configured to determine a strain on the downhole component during running of the downhole component to depth in a borehole.

2. The apparatus of claim 1, further comprising a communication line operatively connecting the fiber optic sensor and the interrogation assembly.

3. The apparatus of claim 2, wherein the communication line is a fiber optic cable.

4. The apparatus of claim 1, wherein the fiber optic sensor is an optical fiber sensor.

5. The apparatus of claim 4, wherein the fiber optic sensor is a distributed fiber optic strain monitoring cable.

6. The apparatus of claim 1, wherein the interrogation assembly is configured as part of the downhole component.

7. The apparatus of claim 6, further comprising a data logger configured to record data from at least one of the interrogation assembly and the processing unit.

8. The apparatus of claim 1, wherein the downhole component is a housing configured to mimic the physical properties of a downhole tool.

9. The apparatus of claim 1, wherein the downhole component is operatively connected to a production string.

10. The apparatus of claim 1, wherein the interrogation assembly is on a ground surface and in operative communication with the fiber optic sensor.

11. The apparatus of claim 1, wherein the fiber optic sensor is disposed along a central axis of the downhole component.

12. The apparatus of claim 1, wherein the processing unit is configured to continuously determine a strain on the downhole component during running of the downhole component to depth.

13. The apparatus of claim 1, wherein the processing unit is configured to periodically determine a strain on the downhole component during running of the downhole component to depth.

14. The apparatus of claim 1, wherein the processing unit is configured to determine a strain on the downhole component at a potential landing site.

15. The apparatus of claim 1, wherein the downhole component is an electrical submersible pump.

16. A method of monitoring strain on a downhole component, the method comprising:
disposing a length of an fiber optic sensor in a fixed relationship relative to a downhole component, the fiber optic sensor configured to deform in response to deformation of the downhole component, the fiber optic sensor defining a continuous distributed sensor;
running the downhole component into a borehole to a potential landing site;
transmitting an electromagnetic interrogation signal into the fiber optic sensor during running of the downhole component;
receiving reflected signals from the fiber optic sensor during running of the downhole component; and
determining a strain on the downhole component from the received reflected signal during the running of the downhole component.

17. The method of claim 16, further comprising recording the received reflected signals.

18. The method of claim 16, wherein the determining step occurs in situ.

19. The method of claim 16, wherein the fiber optic sensor is disposed along a central axis of the downhole tool.

20. The method of claim 16, further comprising determining a strain on the downhole component at the potential landing site of the downhole component.

21. The method of claim 16, further comprising transmitting at least one of the received reflected signal and the determined strain to a surface component.

22. The method of claim 16, wherein the determining step occurs continuously during the running of the downhole component.

23. The method of claim 16, wherein the determining step occurs periodically during the running of the downhole component.
